(19) United States
(12) Patent Application Publication
(10) Pub. No.: US 2014/0072404 A1
(43) Pub. Date: Mar. 13, 2014

(54) BLADE WHEEL FOR A CONTINUOUS-FLOW MACHINE AND METHOD FOR PRODUCING A TURBINE WHEEL FOR A CONTINUOUS-FLOW MACHINE

(71) Applicant: Robert Bosch GmbH, Stuttgart (DE)

(72) Inventors: Gaetan Deromelaere, Kornwestheim (DE); Bernd Reinsch, Ludwigsburg (DE); Andreas Burghardt, Stuttgart (DE); Jochen Rager, Bisingen (DE)

(73) Assignee: Robert Bosch GmbH, Stuttgart (DE)

(21) Appl. No.: 14/015,356

(22) Filed: Aug. 30, 2013

(30) Foreign Application Priority Data
Sep. 7, 2012 (DE) 10 2012 215 895.2

(51) Int. Cl. F02B 37/16

(52) U.S. Cl. CPC F02B 37/16
USPC 415/116; 29/889.6

(57) ABSTRACT

A turbine wheel for a continuous-flow machine includes a centrally arranged hub with circumferentially arranged blades and a pressure equalizing channel. The hub is configured to enclose a cavity, and a resulting principle axis of inertia of the turbine wheel coincides with an axis of rotation of the turbine wheel. The pressure equalizing channel is configured to fluidically connect the cavity to at least one axial end face of the hub and to an environment of the turbine wheel. A diameter of the pressure equalizing channel is smaller than a diameter of the cavity. In one embodiment, the turbine wheel is for an exhaust gas turbocharger.

This application claims priority under 35 U.S.C. §119 to patent application no. DE 10 2012 215 895.2, filed on Sep. 7, 2012 in Germany, the disclosure of which is incorporated herein by reference in its entirety.

### BACKGROUND

The present disclosure relates to a turbine wheel for a continuous-flow machine and to a method for producing a turbine wheel for a continuous-flow machine.

In the case of a turbine wheel for a continuous-flow machine, e.g. a rotor of an exhaust gas turbocharger, the speed of rotation during operation is high, as a result of which large radial forces act in the turbine wheel. When the speed of rotation is changed, the mass moment of inertia of the turbine wheel counteracts the change and thus delays adaptation to a current load situation.

JP 2007-120409 A describes a turbine wheel of an exhaust gas turbocharger.

### SUMMARY

Given this background, the present disclosure presents a turbine wheel for a continuous-flow machine and a method for producing a turbine wheel for a continuous-flow machine in accordance with the description below. Advantageous embodiments can be obtained from the following description.

In an internal combustion engine, a quantity of exhaust gas from the internal combustion engine can rise or fall directly as a response to a change in a quantity of fuel burned. The change in the quantity of exhaust gas results in a change in the load situation at an exhaust gas turbocharger coupled to the internal combustion engine. Owing to the mass moment of inertia of the turbine wheel of the exhaust gas turbocharger, which rotates during the operation of the exhaust gas turbocharger, the exhaust gas turbocharger can respond to the change with a delay. At high speeds of rotation, the mass moment of inertia of the turbine wheel can have a great effect on the response behavior of the exhaust gas turbocharger.

A reduction in the mass moment of inertia of the turbine wheel can advantageously be achieved by means of a hollow in at least part of the turbine wheel. It is thereby possible to enable a quicker response to load changes in the case of an exhaust gas turbocharger. By means of a small pressure equalizing channel, e.g. a small pressure equalizing bore, in the turbine wheel, it is possible to compensate for a change in the volume of a fluid in the hollow in the case of temperature changes. By means of the hollow, it is thus possible to reduce an overall weight of the turbine wheel and to save material and costs for the turbine wheel.

The present disclosure provides a turbine wheel for a continuous-flow machine, in particular for an exhaust gas turbocharger, wherein the turbine wheel has the following features:

a centrally arranged hub with circumferentially arranged blades, wherein a cavity is arranged in the interior of the hub, and a resulting principal axis of inertia of the turbine wheel coincides with an axis of rotation of the turbine wheel; and

a pressure equalizing channel between the cavity and at least one axial end face of the hub, wherein the pressure equalizing channel connects the cavity fluidically to an environment of the turbine wheel, and a diameter of the pressure equalizing channel is smaller than a diameter of the cavity.

The term “turbine wheel” can be taken to include a rotor wheel, e.g. a blade wheel of a turbine, a motor or a machine. A turbine wheel can be a compressor wheel of a compressor, for example. A continuous-flow machine can be a turbomachine configured to transfer energy between a fluid and the machine.

The term “exhaust gas turbocharger” can be taken to mean a machine for removing energy from the exhaust gas in a turbine and compressing fresh air in a compressor, wherein the turbine and the compressor are coupled directly by a shaft. A hub can be a wheel body. The hub can be rotationally symmetrical. A blade can be denoted as a vane or blade. The hub can be denoted as a carrier for the blades. The blades are configured to use flow processes to take energy from the fluid flowing around them during operation and to transfer the energy to the hub. The blades are securely connected to the hub. The blades can be connected integrally to the hub. A cavity can be a hollow. The cavity can have a round, oval, rectangular, polygonal or annular shape, for example. In particular, the cavity can have predominately curved or arcuate inner walls. The cavity can be divided into a plurality of chambers. The cavity can have an opening cross section toward the pressure equalizing channel which is smaller than a mean cross section of the cavity. Said diameter of the cavity can be a maximum diameter of the cavity or a diameter of the cavity transversely to the axis of rotation. Apart from the opening cross section to the pressure equalizing channel, the cavity can be completely surrounded by material of the hub. A principal axis of inertia can be a virtual axis of a body, wherein a mass moment of inertia has an extreme value in relation to the virtual axis. In particular, the mass moment of inertia of the turbine wheel can be at a minimum in relation to the principal axis of inertia. A pressure equalizing channel can be a through bore passing through a wall of the hub into the cavity. The diameter of the pressure equalizing channel can be smaller than a length of the pressure equalizing channel. A cross-sectional area of the pressure equalizing channel, e.g. transversely to the axis of rotation, can be smaller than a cross-sectional area of the cavity, e.g. transversely to the axis of rotation. Here, the cross-sectional area of the pressure equalizing channel can be smaller than the cross-sectional area of the cavity at the level of the end face of the hub, at the level of the transition between the pressure equalizing channel and the cavity or at any position between the cavity and the end face, for example. Depending on the embodiment, the diameter of the pressure equalizing channel can be constant or variable, e.g. stepped, over the overall length of the pressure equalizing channel. The pressure equalizing channel can extend parallel or obliquely to the axis of rotation. An axial end face of the hub can be aligned substantially perpendicular to the axis of rotation. The turbine wheel can have two end faces arranged opposite one another. A wheel back can be arranged on one of the end faces, while a triple square can be arranged on the other end face. At least one of the end faces can have an interface for coupling the turbine wheel to a turbine shaft.

The cavity can be embodied as a torus around the axis of rotation. A torus can be a body of revolution with any desired cross-sectional area. For example, the cross-sectional area of the torus can be round, oval or polygonal. The torus can be a closed annular cavity. There can be material of the hub present in the center of the torus. A torus can form the cavity further away from the axis of rotation, while maintaining the same volume as a disk, for example, and thus effect a greater reduction in the mass moment of inertia than the disk.

In its interior, the hub can have a further cavity, which is separated from the cavity by a partition wall. The cavity and the further cavity can be connected fluidically to one another. The hub can have more than two cavities, e.g. three cavities, four cavities, five cavities or more than five cavities. The cavities can be arranged spaced apart from one another. Outer walls of the hub can be connected to one another between two cavities by the partition wall. The partition wall allows a supporting structure in the interior of the hub in order to ensure the stability of the hub at high speeds of rotation.

For example, the partition wall can be configured as a disk aligned transversely to the axis of rotation. The disk can be of solid configuration or can have at least one through opening, e.g. a bore.

Irrespective of its embodiment, the partition wall can have at least one through opening in order to connect the cavity and the further cavity fluidically to one another. The partition wall can also be formed by a plurality of ribs or spokes, thus forming through openings between the ribs or spokes. A ribbed configuration or a spoke-type configuration can contribute to the saving of material.

A plurality of through openings arranged in the partition wall can be arranged on a common circle of revolution, for example. The through openings can have a round, oval or polygonal cross-sectional areas, for example. By means of a plurality of through openings, it is possible to save weight without significant loss of stability.

According to one embodiment, the further cavity can be connected fluidically to the environment by a further pressure equalizing channel. In the interior of the hub, the further cavity can be separated fluidically from the cavity. The pressure equalizing channel and the further pressure equalizing channel can be routed to the same end face or to opposite end faces of the hub. By means of the further pressure equalizing channel, it is possible to reduce an overall length of the two individual pressure equalizing channels.

The diameter of the pressure equalizing channel can be smaller at the end wall than a maximum diameter of the cavity transversely to the principal axis of inertia. At the end wall, the load on the hub is particularly high, and therefore the pressure equalizing channel can be just large enough in the region of the end face to enable a small volume of fluid to escape from the cavity when the cavity heats up and to enter the cavity when the cavity cools down.

The pressure equalizing channel can be arranged laterally offset with respect to the axis of rotation in the hub. The pressure equalizing channel can extend along the axis of rotation in the hub. It is also possible for the pressure equalizing channel to extend at an angle to the axis of rotation. For example, the pressure equalizing channel can be used to balance the turbine wheel.

A method for producing a turbine wheel for a continuous-flow machine, in particular for an exhaust gas turbocharger, comprises the following steps:

Forming a hub of the turbine wheel, wherein blades are formed around the hub and the hub surrounds a cavity, wherein a resulting principal axis of inertia of the turbine wheel coincides with an axis of rotation of the turbine wheel; and

Integrating a pressure equalizing channel between the cavity and at least one axial end face of the hub, wherein the pressure equalizing channel connects the cavity fluidically to the environment of the turbine wheel, and a diameter of the pressure equalizing channel is smaller than a diameter of the cavity.

A primary forming method can be used in the forming step in order to form the hub and the blades. A primary forming method can be taken to mean a casting method, a sintering method or a printing method, for example. By means of a primary forming method, the cavity can be given its final form within the hub.

A joining method can be used in the forming step in order to form the hub and the blades. The term “joining method” can be taken to mean a welding method, a soldering method or a mechanical connection method, for example. By means of a joining method, individual parts of the turbine wheel can be produced economically and in a simple manner and then connected to form the turbine wheel.

### BRIEF DESCRIPTION OF THE DRAWINGS

The disclosure is explained below in greater detail by way of example with reference to the attached drawings, in which:

FIG. 1 shows a sectioned illustration of a turbine wheel with possible regions for cavities in accordance with an illustrative embodiment of the present disclosure;

FIG. 2 shows a flow diagram of a method for producing a turbine wheel in accordance with one illustrative embodiment of the present disclosure;

FIG. 3 shows a sectioned illustration of a turbine wheel with cavities in a first and a second region in accordance with one illustrative embodiment of the present disclosure;

FIG. 4 shows a sectioned illustration of a turbine wheel with cavities in a first and a third region in accordance with one illustrative embodiment of the present disclosure;

FIG. 5 shows a sectioned illustration of a turbine wheel with cavities in a second and a third region in accordance with one illustrative embodiment of the present disclosure;

FIG. 6 shows a sectioned illustration of a turbine wheel with cavities in a first, second and third region in accordance with one illustrative embodiment of the present disclosure;

FIG. 7 shows a sectioned illustration of a turbine wheel with a cavity in the form of a torus in accordance with one illustrative embodiment of the present disclosure;

FIG. 8 shows a sectioned illustration of a turbine wheel with a cavity in the form of a torus and a further cavity in accordance with one illustrative embodiment of the present disclosure;

FIG. 9 shows a sectioned illustration of a cutaway portion of a turbine wheel with a partition wall in accordance with one illustrative embodiment of the present disclosure;

FIG. 10 shows a sectioned illustration of a cutaway portion of a turbine wheel with a pierced partition wall in accordance with one illustrative embodiment of the present disclosure;

FIG. 11 shows a sectioned illustration of a turbine wheel with a cavity and a pressure equalizing channel in accordance with one illustrative embodiment of the present disclosure;

FIG. 12 shows a sectioned illustration of a turbine wheel with a cavity and a pressure equalizing channel in accordance with another illustrative embodiment of the present disclosure; and

FIG. 13 shows a diagrammatic illustration of a continuous-flow machine in accordance with one illustrative embodiment of the present disclosure.

In the following description of preferred illustrative embodiments of the present disclosure, identical or similar reference signs are used for elements with a similar action illustrated in the various figures, and the description of said elements is not repeated.

### DETAILED DESCRIPTION

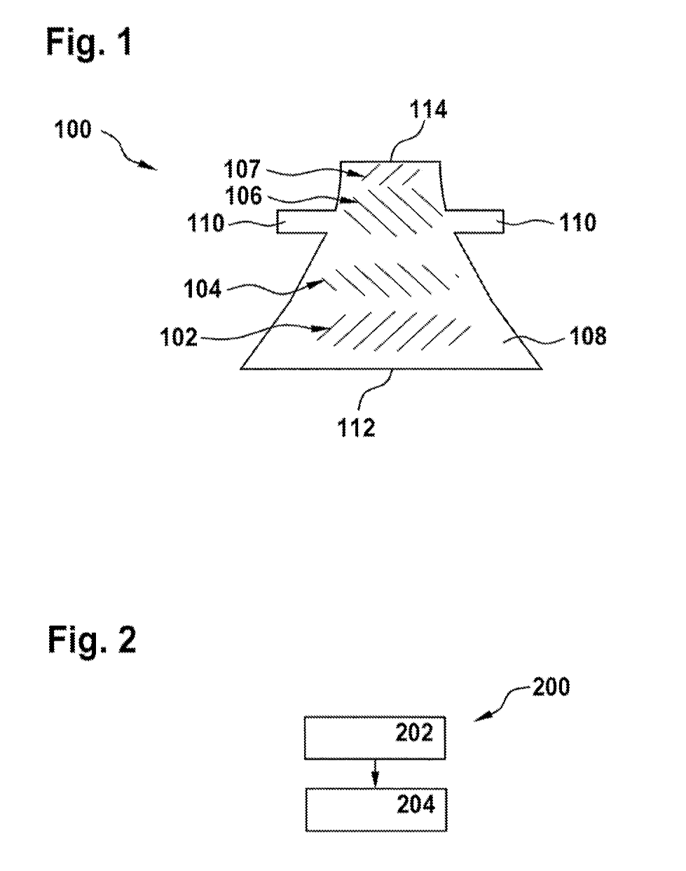

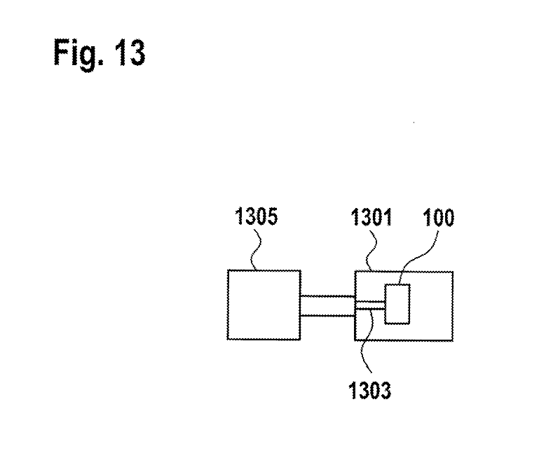

FIG. 1 shows a sectioned illustration of a turbine wheel 100 with possible regions 102, 104, 106, 107 for cavities in accordance with one illustrative embodiment of the present disclosure. The turbine wheel 100 can be used for a continuous-flow machine, e.g. an exhaust gas turbocharger on a vehicle with an internal combustion engine, of the kind shown by way of example in FIG. 13. The sectioned illustration of the turbine wheel 100 which is shown extends along the envisaged axis of rotation of the turbine wheel 100.

The turbine wheel 100 has a hub 108 and blades 110 connected thereto. Only stubs of the blades 110 are visible in the sectioned illustration. The hub 108 has a rotationally symmetrical contour. The hub 108 is shaped approximately as a segment of a paraboloid of rotation or of a hyperboloid of rotation. An end of the hub 108 situated at the top in the illustration in FIG. 1 has a smaller diameter than an end of the hub 108 situated at the bottom. The top end can be configured as a triple square. The bottom end can be configured as a wheel back. As the first end face 112 of the hub 108, the bottom end is circular and arranged perpendicular to the axis of rotation of the turbine wheel 100. As the second end face 114 of the hub 108, the top end is circular and arranged perpendicular to an axis of rotation of the turbine wheel 100. A curve of intersection between the blades 110 and a circumferential surface of the hub 108 has approximately the shape of a helix. The blades 110 extend obliquely along the hub 108. The blades 110 extend approximately over a length of the hub 108. The blades 110 are therefore situated predominantly in front of and behind a section plane used as a basis for the illustration and are depicted only partially in the sectioned illustration.

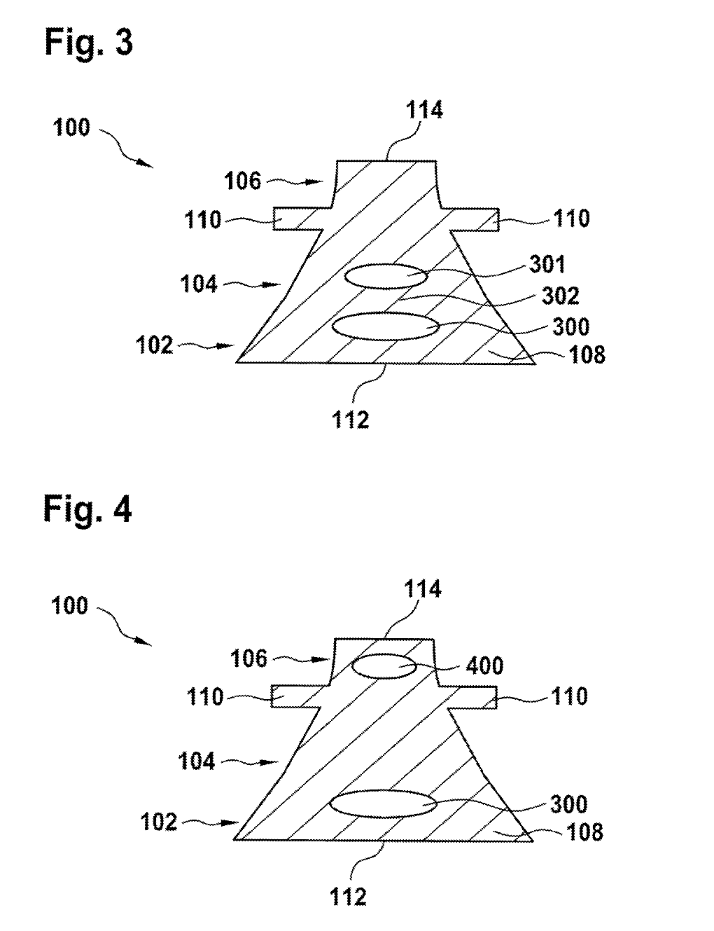

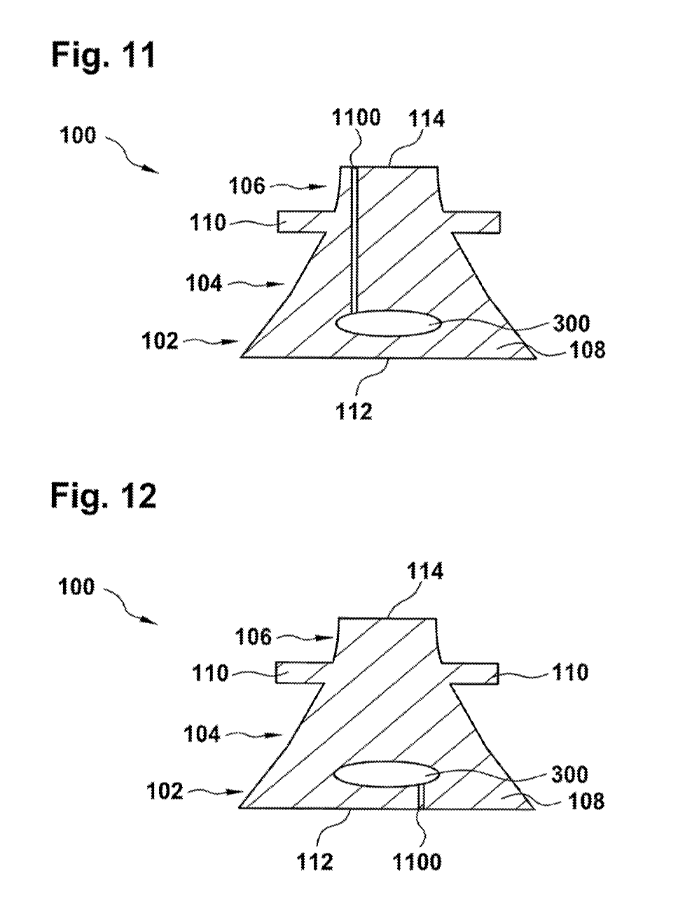

The possible regions 102, 104, 106, 107 for cavities are distributed over the body of the hub 108. A first region 102 is arranged close to the first end face 112, and a fourth region 107 is arranged close to the second end face 114. A second region 104 and a third region are arranged between the first region 102 and the fourth region 107, wherein the second region 104 is arranged adjoining the first region 102 and thus closer to the first end face 112 than the second end face 114. The third region 106 is arranged adjoining the fourth region 107 and thus close to the second end face 114. Apart from the side walls of the hub 108, which connect the end faces 112, 114, the regions 102, 104, 106, 107 can extend over the entire width of the hub 108, transversely to the axis of rotation of the hub 108. In the region of the second end face 114, the hub 108 can have a depression, which can extend into the fourth region 107. A cavity of the kind shown, for example, in FIG. 3 can be arranged in one of the regions 102, 104, 106, 107. It is also possible for the cavity to extend over several of the regions 102, 104, 106, 107. The hub 108 can have more than one cavity. A plurality of cavities can be arranged within one of the regions 102, 104, 106, 107 or in several of the regions 102, 104, 106, 107. The cavity or cavities is/are connected to an environment of the turbine wheel 100 by one or more pressure equalizing channels of the kind shown by way of example in FIGS. 11 and 12. Here, one pressure equalizing channel can be embodied as a tubular perforation. A plurality of separate cavities can be connected to the environment by separate pressure equalizing channels. In this case, each cavity can be connected to the environment by one pressure equalizing channel. Apart from the cavity or cavities, the hub 108 can be of solid configuration.

According to one illustrative embodiment, the turbine wheel 100 shown in FIG. 1 is a turbine wheel 100 for an exhaust gas turbocharger with regions 102, 104, 106, 107 for cavities. In exhaust gas turbochargers, turbine wheels 100 of different materials are employed. The shapes of such turbine wheels 100 are very similar, despite varying materials.

The turbine wheel 100 has a plurality of vanes 110, which are attached to the trumpet-shaped hub 108. In contrast to known turbine wheels, on which the hub is generally of solid configuration, making the turbine wheels 100 relatively heavy, the hub 108 is not of solid configuration here. In comparison to a known turbine wheel, this leads to a lower mass moment of inertia and, as a result, to a quicker response behavior of the exhaust gas turbocharger.

The weight of the turbine wheel 100 has a great influence on the mass moment of inertia and hence on the response behavior of the exhaust gas turbocharger. Hollowing out the turbine wheel 100 by means of cavities in the hub 108 leads to a significant reduction in the weight of the turbine wheel and, by way of the lower mass moment of inertia, to a perceptible improvement in the dynamic behavior of the exhaust gas turbocharger.

The hollowing out of the turbine wheel 100, here with a continuous wheel back on the end 112 of the turbine wheel 100, the end facing a shaft of the turbine wheel 100, is accomplished by introducing cavities in the region 102 of the wheel back 112 and/or in the region 106, 107 of the triple square, which is arranged on the axially opposite end 114. It is thereby possible to reduce the overall weight of the turbine wheel 100. Owing to resulting savings of material, the costs for materials and hence the overall costs of the turbine wheel 100 are lowered. The cavities can be produced by casting methods, methods involving powder technology, e.g. metal injection molding (MIM), joining methods, e.g. welding, soldering, mechanical connections, or by methods involving the building up of layers, e.g. laser sintering and 3-D printing.

The cavities can be formed in various regions 102, 104, 106, 107 of the hub 108. One or more cavities can be arranged at end 112, in the lower region 102 of the hub 108, close to the wheel back. At least one cavity can likewise be arranged in the central region 104 of the hub 108. At least one further cavity can be arranged in the upper region 106 of the hub 108, in the region of the triple square on end 114. As an option, there can be a hollow or no hollow in the region of the triple square 114. FIG. 1 shows an illustration of the possible cavity positions 102, 104, 106, 107.

FIG. 2 shows a flow diagram of a method 200 for producing a turbine wheel in accordance with one illustrative embodiment of the present disclosure. The turbine wheel can be a turbine wheel of the kind shown in the other figures. The method 200 has a forming step 202 and an integration step 204.

In the forming step 202, a hub of the turbine wheel is formed. During this process, blades or vanes are formed around the hub. The hub is shaped in such a way that it encloses at least one cavity in the interior thereof. In the integration step 204, at least one pressure equalizing channel is integrated between the at least one cavity and at least one axial end face of the hub. By means of the at least one pressure equalizing channel, the at least one cavity is connected fluidically to the environment of the turbine wheel. Here, the at least one pressure equalizing channel is embodied in such a way that a cross-sectional area of the at least one pressure equalizing channel is smaller than a cross-sectional area of the at least one cavity.

Steps 202, 204 can be carried out in temporal succession or simultaneously. For example, it is possible for a cavity to be formed first of all in step 202 and then for a pressure equalizing channel to be produced in step 204. As an alternative, the cavity and the pressure equalizing channel can be produced together in one method step. FIG. 3 shows a sectioned illustration of a turbine wheel 100, as described with reference to FIG. 1. According to this illustrative embodiment, the turbine wheel 100 has a first cavity 300 in the first, lower region 102 and a second cavity 301 in the second, central region 104. No cavity is arranged in the third region 106 and in the fourth region. A partition wall 302 is arranged between the two cavities 300, 301. The partition wall can have a thickness corresponding approximately to a height of the cavities 300, 301 in the direction of the axis of rotation of the turbine wheel 100. The first cavity 300 can have a width, measured transversely to the axis of rotation, which corresponds approximately to half the width of the hub 108 at the level of the first cavity 300. In a corresponding manner, the second cavity 301 can have a width which corresponds approximately to half the width of the hub 108 at the level of the second cavity 301. The cavities 300, 301 are formed symmetrically with respect to the axis of rotation. Thus, the turbine wheel 100 is not unbalanced. The cavities 300, 301 each have an oval cross-sectional area. The cavities 300, 301 can each be embodied as an ovoid. In the illustration in FIG. 3, the turbine wheel 100 has cavity 300 in the lower region 102 and in the central region 104. The cavities 300, 301 can be connected by a common pressure equalizing channel or by two separate pressure equalizing channels to the environment of the turbine wheel 100. Depending on the illustrative embodiment, the partition wall 302 can thus be continuous or embodied with a through opening for connecting the cavities 300, 301.

FIG. 4 shows a sectioned illustration of a turbine wheel 100 corresponding to the turbine wheel shown in FIG. 1, having a first cavity 300 in the first, lower region 102 and a second cavity 400 in the third, upper region 106 in accordance with one illustrative embodiment of the present disclosure. No cavity is arranged in the second region 104. As in FIG. 3, the first cavity 300 is arranged close to the first end face 112. The second cavity 400 is arranged close to the second end face 114. The first cavity 300 is separated fluidically from the second cavity 400. Arranged between the first cavity 300 and the second cavity is a partition wall, which is more than three times as thick as a height of one of the cavities 300, 400, for example. The first cavity 300 can have a width which corresponds approximately to half the width of the hub 108 at the level of the first cavity 300. In a corresponding manner, the second cavity 400 can have a width which corresponds approximately to half the width of the hub 108 at the level of the second cavity 400. Each of the two cavities 300, 400 has a pressure equalizing channel (not shown). The pressure equalizing channel connects cavity 300 to the first end face 112 or wheel back. The further pressure equalizing channel connects the further cavity 400 to the second end face 114 or side of the triple square.

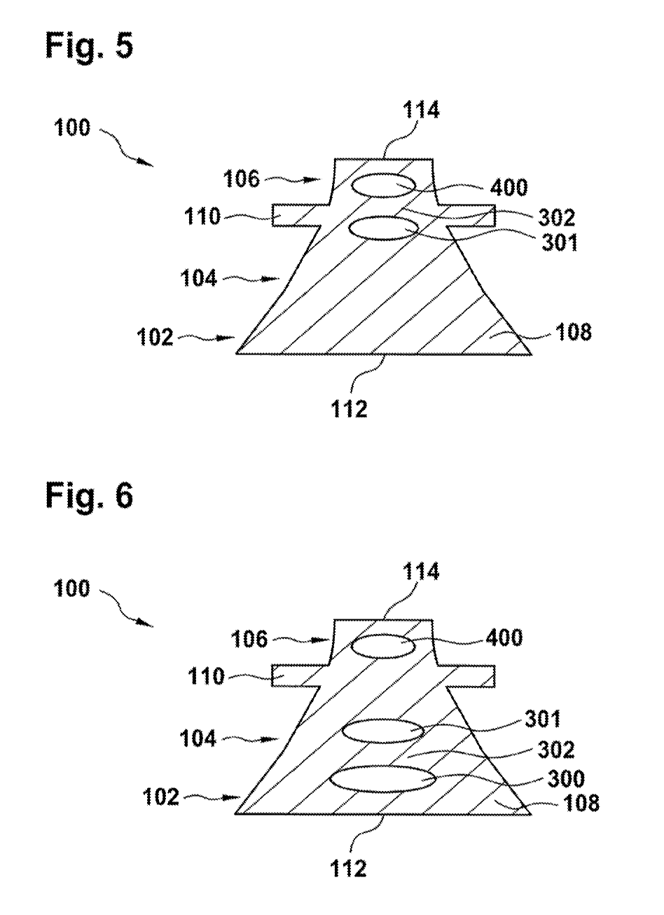

FIG. 5 shows a sectioned illustration of a turbine wheel 100 corresponding to the turbine wheel shown in FIG. 1, having a first cavity 301 in the second, central region 104 and a second cavity 400 in the third, upper region 106 in accordance with one illustrative embodiment of the present disclosure. In contrast to FIG. 3, no cavity is arranged in the first region 102. The partition wall 302 can have a thickness which corresponds approximately to a height of one of the cavities 301, 400. The pressure equalizing channel connects cavity 300 to the second end face 114. The cavities 301, 400 can be connected to the environment of the turbine wheel 100 by a common pressure equalizing channel or by two separate pressure equalizing channels. Depending on the illustrative embodiment, the partition wall 302 can thus be continuous or embodied with a through opening for connecting the cavities 300, 301.

FIG. 6 shows a sectioned illustration of a turbine wheel 100 corresponding to the turbine wheel shown in FIG. 1, having cavities 300, 301, 400 in the first, lower region 102, the second, central region 104 and the third, upper region 106 in accordance with one illustrative embodiment of the present disclosure. As in FIG. 3, cavities 300, 301 are separated from one another by the partition wall 302. As in FIG. 4, cavity 400 is arranged in the third region 106. Cavities 301, 400 are separated from one another by a further partition wall. The further partition wall has a greater thickness than the partition wall between cavities 300, 301. The cavities 300, 301, 400 are aligned coaxially.

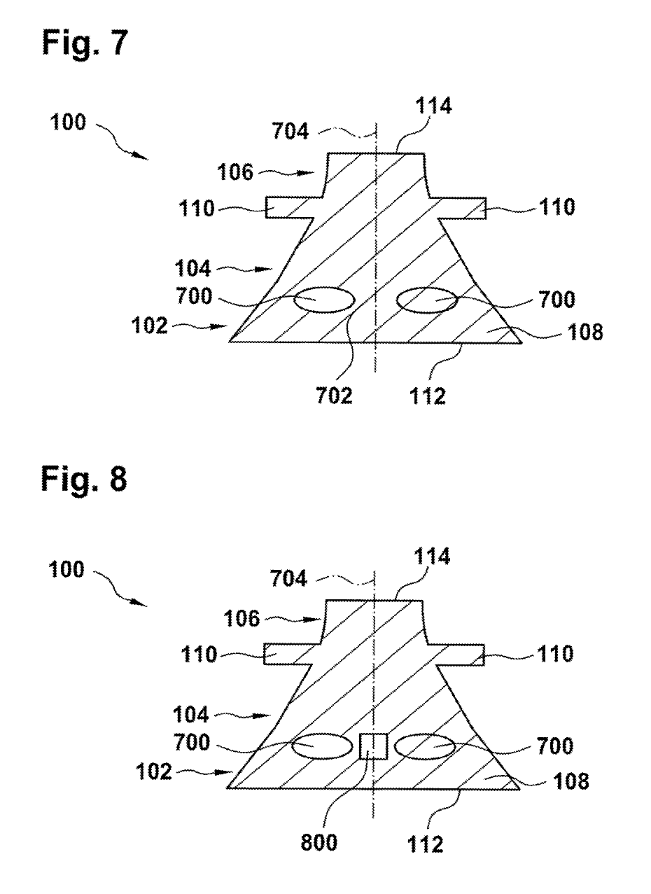

FIG. 7 shows a sectioned illustration of a turbine wheel 100 corresponding to the turbine wheel shown in FIG. 1, having a cavity 700 in the form of a torus, in accordance with one illustrative embodiment of the present disclosure. The cavity 700 is thus embodied as a toroidal volume. The cavity 700 is arranged in the first, lower region 102. The turbine wheel 100 does not have any cavities in the second region 104 and the third region 106. The cavity 700 has a circular cross section all the way round. A material bridge 702 is formed in a center of the cavity 700. The cavity 700 has a neutral effect on the center of gravity and is arranged coaxially with the axis of rotation 704 within the hub 108. A pressure equalizing channel connects the cavity 700 to the first end face 112.

FIG. 8 shows a sectioned illustration of a turbine wheel 100 corresponding to the turbine wheel shown in FIG. 1, having a cavity 700 in the form of a torus and a further cavity 800, in accordance with one illustrative embodiment of the present disclosure. Cavity 700 is embodied as described with reference to FIG. 7. The further cavity 800 is arranged centrally within the material bridge of the cavity 700 embodied as a torus. The further cavity 800 has a cylindrical shape. The cavities 700, 800 have corresponding heights. The cavities 700, 800 can be connected to the environment of the turbine wheel 100 by a common pressure equalizing channel or by two separate pressure equalizing channels routed to the first end face or to the second end face. Depending on the illustrative embodiment, the material bridge serving as a partition wall between the cavities 700, 800 can thus be continuous or embodied with a through opening for connecting the cavities 700, 800.

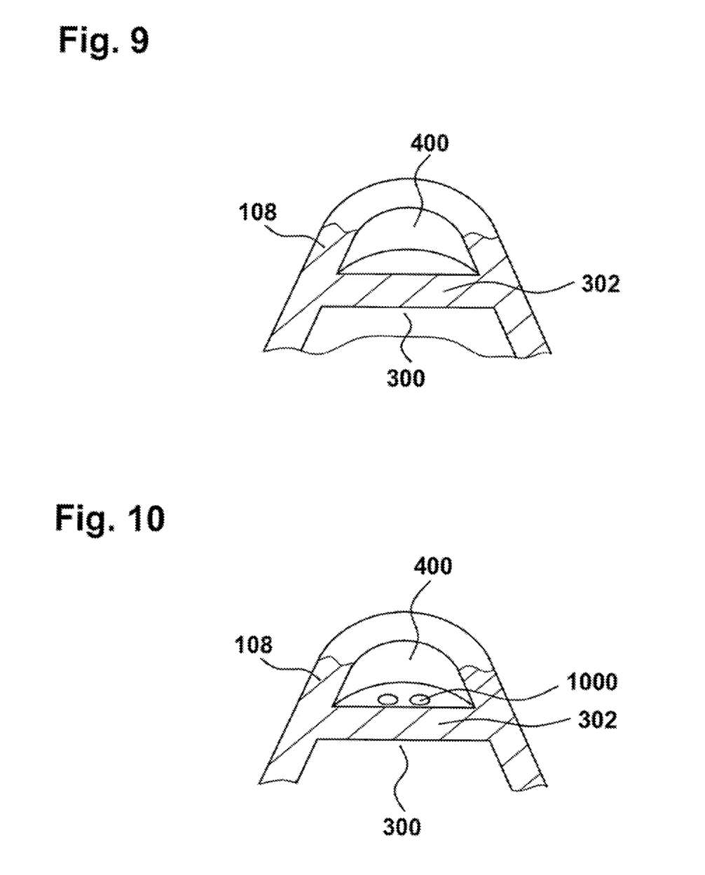

FIG. 9 shows a sectioned illustration of a three dimensional representation of a portion of a hub 108 of a turbine wheel having a partition wall 302 in accordance with one illustrative embodiment of the present disclosure. The hub 108 can be the hub of a turbine wheel of the kind shown in the other figures. According to this illustrative embodiment, the hub 108 has a first cavity 300 and a second cavity 400 separated therefrom. The first cavity 300 is separated from the second cavity 400 by the partition wall 302. The partition wall 302 is arranged in the form of a disk perpendicular to an axis of rotation of the hub 108. The hub 108 thus has a connection embodied as a disk. The hub 108 has a trumpet shape. A wall thickness of the hub 108 is uniform. The partition wall 302 has approximately the same thickness as the wall thickness of the hub 108. The first cavity 300 and the second cavity 400 have tapering cross-sectional areas. The partition wall 302 is connected to the wall by small corner radii. According to this illustrative embodiment, the partition wall 302 is of solid configuration, i.e. without a through opening for connecting the two cavities 300, 400.

FIG. 10 shows a sectioned illustration of a three dimensional representation of a portion of a hub 108 of a turbine wheel with a pierced partition wall 302 in accordance with one illustrative embodiment of the present disclosure. The hub 108 corresponds to the hub in FIG. 9. In addition, the partition wall 302 has one or more through holes 1000, which connect the first cavity 300 fluidically to the second cavity 400. If the partition wall 302 has a plurality of through holes 1000, these can be arranged arbitrarily or in a regular pattern on the circumference of a circle or on a circle of revolution in the partition wall 302 and can be connected to the cavities 300, 400. For example, the partition wall 302 can have two or more through holes 1000.

According to this illustrative embodiment, the partition wall 302 is not of solid configuration but is pierced. As an alternative, it is also possible for the partition wall 302 to have a spoke-type configuration or a ribbed configuration, i.e. to be formed by a plurality of ribs or spokes.

FIG. 11 shows a sectioned illustration of a turbine wheel 100 corresponding to the turbine wheel shown in FIG. 1, having a cavity 300 and a pressure equalizing channel 1100 in accordance with one illustrative embodiment of the present disclosure. The cavity 300 is arranged in the second region 104. The turbine wheel 100 does not have any cavities in the first region 102 and the third region 106. The pressure equalizing channel 1100 serves as an upward gas equalizing channel and extends in a straight line, e.g. as a straight bore with a small diameter from the cavity 300 to the second end face 114, and thus connects the cavity 300 fluidically to an environment of the turbine wheel 100. The pressure equalizing channel 1100 is arranged laterally offset with respect to the axis of rotation. For example, the pressure equalizing channel 1100 can have a diameter which is smaller than one tenth of the diameter of the cavity 300. The pressure equalizing channel 1100 can have a length which corresponds to at least half the height of the hub 108. As alternative, the pressure equalizing channel 1100 can also extend along the axis of rotation of the hub 108. A corresponding pressure equalizing channel 1100 can also be used in conjunction with the previous illustrative embodiments.

FIGS. 3 to 11 show various illustrative embodiments of example combinations of cavities in the regions 102, 104, 106, 107. In FIG. 3, a combination of cavities 300, 301 in regions 102, 104 is illustrated. In FIG. 4, a combination of cavities 300, 400 in regions 102, 106 is illustrated. In FIG. 5, a combination of cavities 301, 400 in regions 104, 106 is illustrated. In FIG. 6, a combination of cavities 300, 301, 400 in regions 102, 104, 106 is illustrated. At the same time, any other combinations are also possible.

The cavities in the regions 102, 104, 106, 107 can, for example, be embodied as continuous disk-shaped volumes, e.g. ellipsoids, semi-ellipsoids, right cylinders, truncated cones, polyhedra, closed bodies etc. The cavities in the regions 102, 104, 106, 107 can likewise be embodied, for example, as toroidal volumes with a cross section in the form of an ellipse, semi-ellipse, circle, parallelepiped, trapezium, parallelogram, polygon etc., as shown in FIG. 11. In this case, there can be an additional axial central free space, as shown in FIG. 12. The interspaces between the cavities, e.g. in regions 102, 104 or regions 104, 106 or regions 102, 106 can be of solid configuration, i.e. configured as a continuous disk, as shown in FIG. 9, or with free spaces, e.g. spokes or as a pierced hole, as shown in FIG. 10.

In all versions, a gas equalizing channel is provided. It can be formed upward, as shown by way of example in FIG. 11, and additionally or alternatively downward, as shown by way of example in FIG. 12.

FIG. 12 shows a sectioned illustration of a turbine wheel 100 corresponding to the turbine wheel shown in FIG. 1, having a cavity 300 and a pressure equalizing channel 1100 as a gas equalizing channel in accordance with a further illustrative embodiment of the present disclosure. Here, the cavity 300 corresponds to the cavity in FIG. 11. In contrast to FIG. 11, the pressure equalizing channel 1100 extends from the first end face 112 to the cavity 300. In this illustrative embodiment too, the pressure equalizing channel 1100 is arranged laterally offset with respect to the axis of rotation. For example, the pressure equalizing channel 1100 can have a diameter which is smaller than one tenth of the diameter of the cavity 300. The pressure equalizing channel 1100 can have a length which corresponds to less than half the height of the hub 108. As an alternative, it is also possible for the pressure equalizing channel 1100 to extend along the axis of rotation of the hub 108. A corresponding pressure equalizing channel 1100 can also be employed in conjunction with the previous illustrative embodiments.

FIG. 13 shows a schematic illustration of a continuous-flow machine 1301 having a turbine wheel 100 in accordance with one illustrative embodiment of the present disclosure. The turbine wheel 100 can be a turbine wheel having at least one cavity, as described with reference to the preceding figures. The turbine wheel 100 is coupled to a shaft 1303 and rotates during operation about an axis of rotation extending through the shaft 1303. According to this illustrative embodiment, the continuous-flow machine 1301 is embodied as an exhaust gas turbocharger of an internal combustion engine 1305.

In general, the approach of providing at least one cavity in a turbine wheel 100 can be employed wherever there are turbine wheels 100, e.g. in the exhaust gas turbocharger. Here, quality control can be performed effectively by studying metallographic sections.

The illustrative embodiments described and shown in the figures have been selected purely by way of example. Different illustrative embodiments can be combined into or in respect of individual features. It is also possible for one illustrative embodiment to be supplemented by features of another illustrative embodiment. Moreover, method steps according to the disclosure can be repeated and carried out in some sequence other than that described. If an illustrative embodiment includes an “and/or” conjunction between a first feature and a second feature, this is to be interpreted to mean that the illustrative embodiment can have both the first feature and the second feature according to one embodiment and either just the first feature or just the second feature according to another embodiment.

What is claimed is:

1. A turbine wheel for a continuous-flow machine, the turbine wheel comprising:
a centrally arranged hub including circumferentially arranged blades and a cavity arranged in an interior of the hub, the hub configured such that a resulting principal axis of inertia of the turbine wheel coincides with an axis of rotation of the turbine wheel; and
a pressure equalizing channel arranged between the cavity and at least one axial end face of the hub, the pressure equalizing channel configured to fluidically connect the cavity to an environment of the turbine wheel,
wherein a diameter of the pressure equalizing channel is smaller than a diameter of the cavity.

2. The turbine wheel according to claim 1, wherein the cavity is a torus around the axis of rotation.

3. The turbine wheel according to claim 1, wherein:
the hub further includes a further cavity arranged in the interior of the hub, the further cavity separated from the cavity by a partition wall.

4. The turbine wheel according to claim 3, wherein the partition wall is configured as a disk aligned transversely to the axis of rotation.

5. The turbine wheel according to claim 3, wherein the partition wall has at least one through opening configured to fluidically connect the cavity and the further cavity to one another.

6. The turbine wheel according to claim 3, wherein the further cavity is fluidically connected to the environment by a further pressure equalizing channel.

7. The turbine wheel according to claim 1, wherein the diameter of the pressure equalizing channel is smaller at at least one axial end face than a maximum diameter of the cavity transversely to the principal axis of inertia.

8. The turbine wheel according to claim 1, wherein the pressure equalizing channel is arranged laterally offset with respect to the axis of rotation in the hub.

9. A method for producing a turbine wheel for a continuous-flow machine, comprising:
forming a hub of the turbine wheel, wherein blades are formed around the hub and the hub surrounds a cavity, wherein a resulting principal axis of inertia of the turbine wheel coincides with an axis of rotation of the turbine wheel; and
integrating a pressure equalizing channel between the cavity and at least one axial end face of the hub, wherein the pressure equalizing channel connects the cavity fluidically to the environment of the turbine wheel, and a diameter of the pressure equalizing channel is smaller than a diameter of the cavity.

10. The method according to claim 9, wherein forming the hub of the turbine wheel includes using a primary forming method to form the hub and the blades.

11. The method according to claim 10, wherein forming the hub of the turbine wheel includes using a joining method to form the hub and the blades.

12. The turbine wheel according to claim 1, wherein the turbine wheel is for an exhaust gas turbocharger.
